(19) United States
(12) Patent Application Publication
(10) Pub. No.: US 2004/0129885 A1
(43) Pub. Date: Jul. 8, 2004

(54) Optical motion sensor with elongated detection zone and method for elongating detection zone in an optical motion sensor

(75) Inventor: David I. McKenney, Orangevale, CA (US)

Correspondence Address: JOHN P. O'BANION, O'BANION & RITCHEY LLP, 400 CAPITOL MALL SUITE 1550, SACRAMENTO, CA, 95814, US

(73) Assignee: HONEYWELL INTERNATIONAL, INC.

(21) Appl. No.: 10/702,117

(22) Filed: Nov. 4, 2003

Related U.S. Application Data
(63) Continuation of application No. PCT/US02/14026, filed on May 2, 2002.
(60) Provisional application No. 60/288,736, filed on May 4, 2001.

(51) Int. Cl. G01J 5/02

(52) U.S. Cl. 250/353

(57) ABSTRACT

Apparatus and methods are described for extending the detection zone of an optical detection assembly, such as for a motion detector, along an axis without adding additional reflectors or circuitry. The optical detector within the optical detector assembly is positioned astigmatically, off-axis, in relation to an optically curved reflector from which it receives reflected radiation. Electromagnetic radiation incident on the optically curved reflector from an off-axis, astigmatic, beam area is directed to the optical detector to extend the detection area of the motion detector, or other system, along one axis when compared to on-axis detector positioning. By way of example, the optical detection assembly is configured with a pyroelectric detector positioned facing an optically curved mirror comprising a Fresnel reflector at a distance roughly equivalent to the focal length of the optically curved reflector. The resultant infrared motion detector provides an extended detection area along one axis.

### CROSS-REFERENCE TO RELATED APPLICATIONS

This application claims priority from, and is a 35 U.S.C. § 111(a) continuation of, co-pending PCT international application serial number PCT/US02/14026 filed on May 2, 2002 which designates the U.S., and which claims priority from U.S. provisional application serial No. 60/288,736 filed on May 4, 2001. This application also claims priority from U.S. provisional application serial No. 60/288,736 filed on May 4, 2001, incorporated herein by reference.

### STATEMENT REGARDING FEDERALLY SPONSORED RESEARCH OR DEVELOPMENT

Not Applicable

### REFERENCE TO A COMPUTER PROGRAM APPENDIX

Not Applicable

### BACKGROUND OF THE INVENTION

1. Field of the Invention

The invention generally pertains to optical motion detectors for alarm systems and more particularly to an apparatus and method for elongating the detection zone along an axis without adding additional reflective structures.

2. Description of the Background Art

Intrusion and alarms systems often utilize optical detectors, such as visible or infrared, for detecting the presence and movement of humans within a detection area. Typically, detector based systems within the alarm industry incorporate optical sensing provided by motion sensors configured for detecting changes in the received level of infrared, near infrared, or visible portions of the electromagnetic radiation spectrum, or combination thereof, as emitted or reflected from persons moving within the detection zone. A reflector is typically utilized in conjunction with the optical detector within the sensing head of the motion detector so that radiation may be focused toward the head to increase detection sensitivity over an expanded beam area and extended detection zone. Typical reflectors are configured having a “mirrored” front surface, and by way of example these reflectors may alternately be referred to as “mirrors” by virtue of their ability to reflect incident radiation at the desired wavelengths. By way of further definition, the combination of optics utilized within a single motion detector unit are referred to generally as a detector head, or an optical detection assembly. The optics of an optical detector assembly comprise a reflector assembly, an optical detector, and any additional optical components which configure the response of the optical detector.

The detector component in an optical detector assembly is traditionally positioned at the focal point of an optically curved reflector for optimal reception of the reflected radiation. FIG. 1 illustrates an example of a conventional optical detector assembly 10 configured with a Fresnel reflector 12 having a reflective side 14 for directing electromagnetic radiation to a pyroelectric detector 16 (also referred to as a pyroelectric sensor) having a detection surface 18. The optical detection assembly 10 is typically utilized within a motion detector configured to respond to the movement of persons in an associated detection zone. The curved facets of Fresnel reflector 12 are arranged so that the planar Fresnel reflector focuses incident radiation in like manner to a curved reflector, such as a parabolic reflector. From an optical standpoint, Fresnel reflector 12 provides an optically curved reflector for concentrating the incident radiation onto the detector. Pyroelectric detector 16 is arranged with center 26 of Fresnel reflector 12, through which optical axis 20 passes, being aligned and focused upon a center 28 of surface 18 of detector 16. The optical path length 22 along the axis being equal to the focal length 24 of the optically curved surface. When the optical path from reflector to detector lies on the optical axis of the reflector it is referred to herein as “on-axis” detection, and the associated optical detector assembly is referred to herein as an “on-axis” optical detector assembly. It will be appreciated that the term “on-axis” is coined herein for the purpose of denoting distinctions in relation to the present invention, and is not specified in current detection systems as it is considered an inherent property of optical detector assemblies. Optically curved reflectors utilized in pyroelectric detectors generally comprise either (optically curved) Fresnel reflectors, or physically curved reflectors for directing the incident radiation to the detector. Typically, motion detectors incorporating these optical detector assemblies are positioned on a building structure at a height of six feet or more with their optical axis directed downwardly to an area within which motion is to be detected, although a number of other mounting configurations are also commonplace.

The resultant motion detector provides a symmetrical beam coincident with the axis of the reflector that subtends a given arc, a plane through which defines a detection area, or zone. However, detection applications often arise which require that an asymmetrical detection area be provided by the motion detector. Presently, such asymmetrical detection areas are created by changing the optical detector assembly through the addition of reflectors to concentrate peripheral (off-axis) electromagnetic radiation which does not otherwise lie in the beam arc on the axis of the reflector. Augmenting the optical detector assembly with additional mirrors adds complexity and cost to the manufacture of the resultant motion detector.

Therefore a need exists for an optical detection assembly for use in a motion detector that is capable of collecting off-axis radiation without the need of additional reflectors, or other added cost factors. The present invention satisfies those needs, as well as others, and overcomes deficiencies in previously developed solutions.

### BRIEF SUMMARY OF THE INVENTION

The present invention is an optical detector assembly, and associated construction methods, for elongating a detection area without the necessity of adding reflectors. An optical detector, such as an infrared or pyroelectric detector, is positioned for detecting radiation collected by a reflector that is facing the optical detector. Elongation of the detection zone is provided by the present invention as a result of positioning the optical detector in a sufficiently astigmatic relationship, off-axis, with the reflector so as to sufficiently elongate the desired detection axis. Although positioned off-axis with the associated reflector, the optical detector is preferably positioned at a distance from the optical detector which is substantially equivalent to the focal length of the reflector. By way of example, the optical detector is a pyroelectric detector or other detector capable of registering infrared (heat) or near-infrared radiation. Various forms of optically curved reflectors may be utilized for collecting the radiation and directing it toward the infrared detector, such as parabolic, radial, quasi-parabolic, or various Fresnel reflectors.

An object of the invention is to improve the reliability of target detection within a motion detector.

Another object of the invention is to elongate the detection zone of a motion detector.

Another object of the invention is to provide an elongated detection zone without the necessity of adding off-axis reflectors.

Another object of the invention is to provide detection zone elongation within motion detectors utilizing various forms of optical reflectors, such as curved reflectors, faceted reflectors, and Fresnel reflectors.

Another object of the invention is to provide an elongated detection zone in motion detectors that employ a variety of optical detectors such as visible light sensors, near-infrared sensors, infrared sensors, and pyroelectric sensors.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a side view of a conventional optical detection assembly as utilized within a motion detector, shown with standard detector positioning centered on the optical axis of the reflector.

FIG. 2 is a side view of astigmatic positioning within an optical detection assembly according to an embodiment of the present invention, shown with astigmatic, off-axis, positioning of the optical detector in relation to the optical reflector.

FIG. 3 is a side view of astigmatic positioning within an optical detection assembly according to an embodiment of the present invention, shown with astigmatic positioning of an optical detector which is rotated in relation to FIG. 2.

FIG. 4 is a facing view of the astigmatic detector positioning of FIG. 3, which also depicts the direction of elongation.

FIG. 5 is a side view of a detection beam associated with a conventional optical detector assembly utilizing on-axis detector positioning.

FIG. 6 is a side view of a detection beam associated with an astigmatically positioned optical detector assembly, which spreads the detection beam and thereby increases detection zone width, in one plane, in relation to the width provided by conventional optical detector assemblies.

FIG. 7 is a side view of astigmatic positioning within an optical detection assembly according to an embodiment of the present invention, shown utilizing a physically curved reflector.

### DETAILED DESCRIPTION OF THE INVENTION

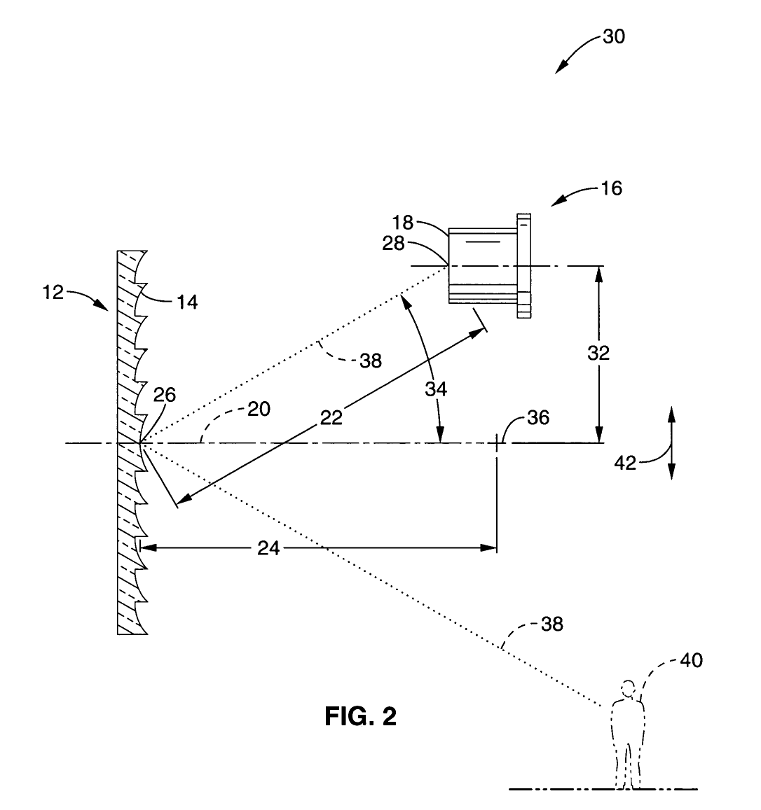

Referring more specifically to the drawings, for illustrative purposes the present invention is embodied in the apparatus generally shown in FIG. 2 through FIG. 7. It will be appreciated that the apparatus may vary as to configuration and as to details of the parts, and that the method may vary as to the specific steps and sequence, without departing from the basic concepts as disclosed herein.

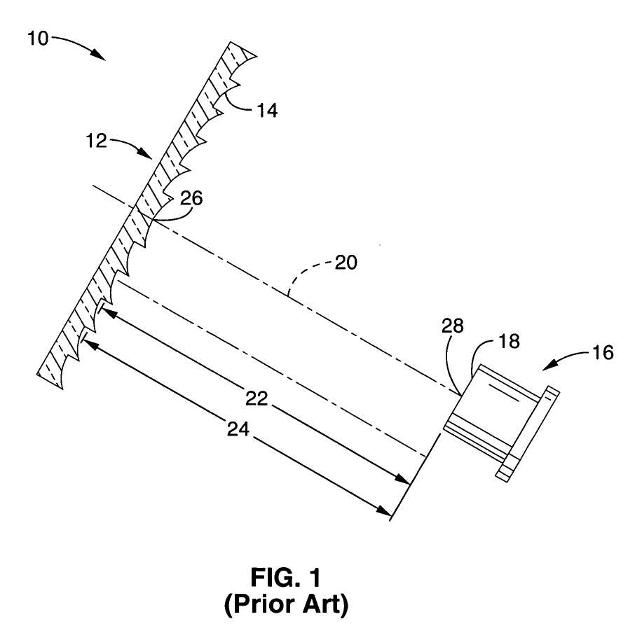

FIG. 2 depicts an optical detection assembly 30 utilizing astigmatic optical detector positioning according to the present invention. Optical detection assembly 30 is shown utilizing the same optically curved reflector as shown in FIG. 1, which comprises a Fresnel reflector 12 having a faceted reflective front surface 14 and a pyroelectric detector 16 having a detection surface 18 shown oriented in the same plane as Fresnel reflector 12. Clearly visible from the figure, pyroelectric detector 16 is positioned off of the optical axis 20 of reflector 12 in a decidedly astigmatic relationship according to an offset distance 32 which corresponds to an angular displacement 34 which exceeds approximately ten degrees (10°) and preferably exceeds about fifteen degrees (15°). Optically curved reflector 12 has a focal point 36, away from which pyroelectric detector 16 has been displaced. It should be recognized that although a pyroelectric detector 16 is described herein as the optical detection element, various other forms of sensors and detectors responsive to incident levels of radiation, such as visible, near-infrared, and infrared, can be utilized with the astigmatic placement taught within the present invention. The astigmatic placement of pyroelectric detector 16 in relation to reflector axis 20 causes differentiation of the optical path with regard to the plane of incident radiation.

A new light path 38 is thereby created in relation to optical axis 20 of reflector 12 from which the astigmatic relationship produces a non-symmetrical increase in the arc subtended by the beam incident on optical detection assembly 30. The non-symmetrical increase in beam size translates to a beneficial increase in detection area along one axis, such that the presence of one or more persons 40 is more readily and accurately registered. The subtended optical field of view provided by the optical detector is thereby elongated in one axis 42 while the perpendicular axis (not shown in FIG. 2) remains unchanged. The distance measured between the reflector and detector is referred to as the optical path length 22. The optical path length 22, is preferably retained equal to the focal length 24 of the reflector 12 as measured from center 26 of optical curvature within optically curved reflector 12 to detection surface 18 of detector 16. Use of focal length positioning results in the maximum coupling of the collected radiation onto the surface of pyroelectric detector 16. Optical detector assemblies for motion detectors manufactured according to the astigmatic placement taught herein provide an elongated detection area in one axis. In the majority of motion detection applications, it is anticipated that the desired axis of elongation will be in the vertical axis to improve the detection of moving persons, especially tall individuals. However, the astigmatic positioning may be equivalently utilized to elongate the detection area along any plane from vertical to horizontal, as desired within a specific motion sensing application. The astigmatic positioning eliminates the necessity for adding reflectors to the optical detector assembly to stretch the detection area along an axis.

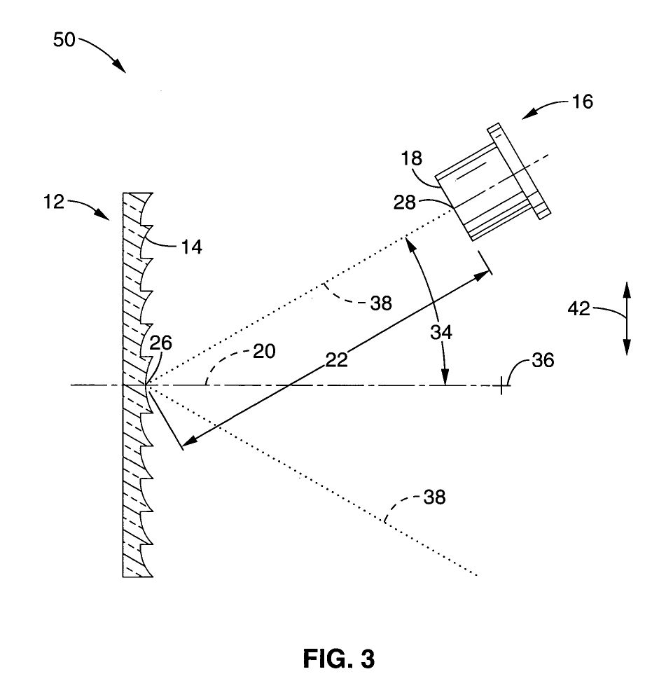

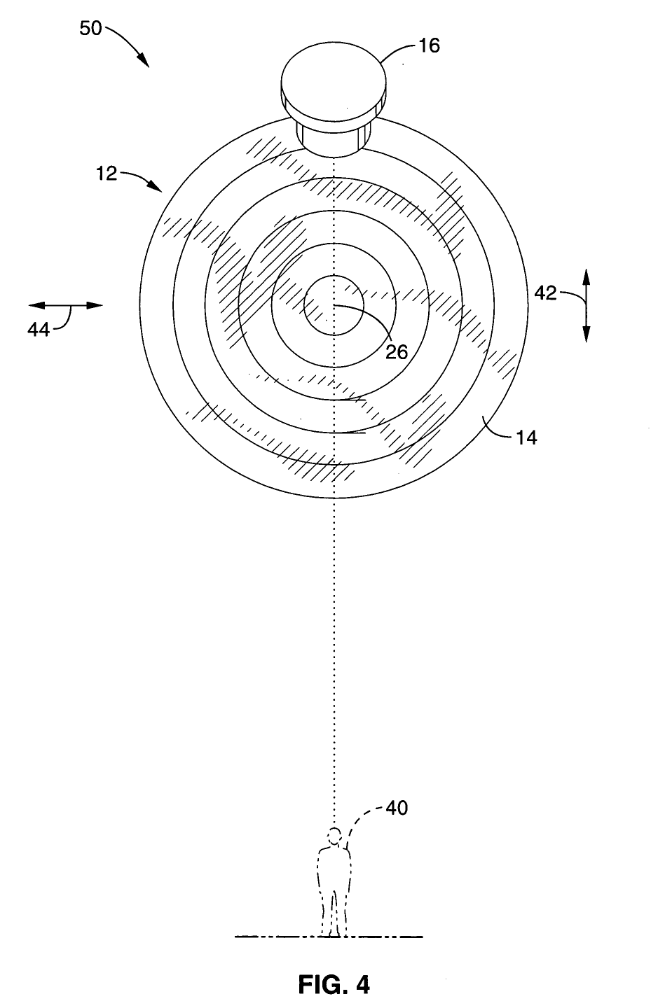

FIG. 3 shows an optical detector assembly 50 in which pyroelectric detector 16 has been canted (rotated) from the astigmatic position shown in FIG. 2, to a position wherein it faces optical center 26 of reflector 12 with detection surface 18 of detector 16 arranged perpendicular to light path 38. It will be appreciated that detector 16 may be rotated by various amounts to alter the amount of surface 18 available for capturing the reflected radiation from the reflector 12, and that the astigmatic position is subject to any intentional displacement that substantially increases the detection area along an axis. FIG. 4 illustrates the embodiment 50 from FIG. 3, shown with astigmatic positioning of the pyroelectric detector 16, or other infrared sensor, in relation to a Fresnel reflector 12. The light path 38 is shown from a detected individual 40 to the surface 14 of Fresnel reflector 12 which is reflected to pyroelectric detector 16. The axis of elongation 42 is visible in the figure across which the arc subtended by the beam is extended, while the non-extended axis 44 remains unchanged.

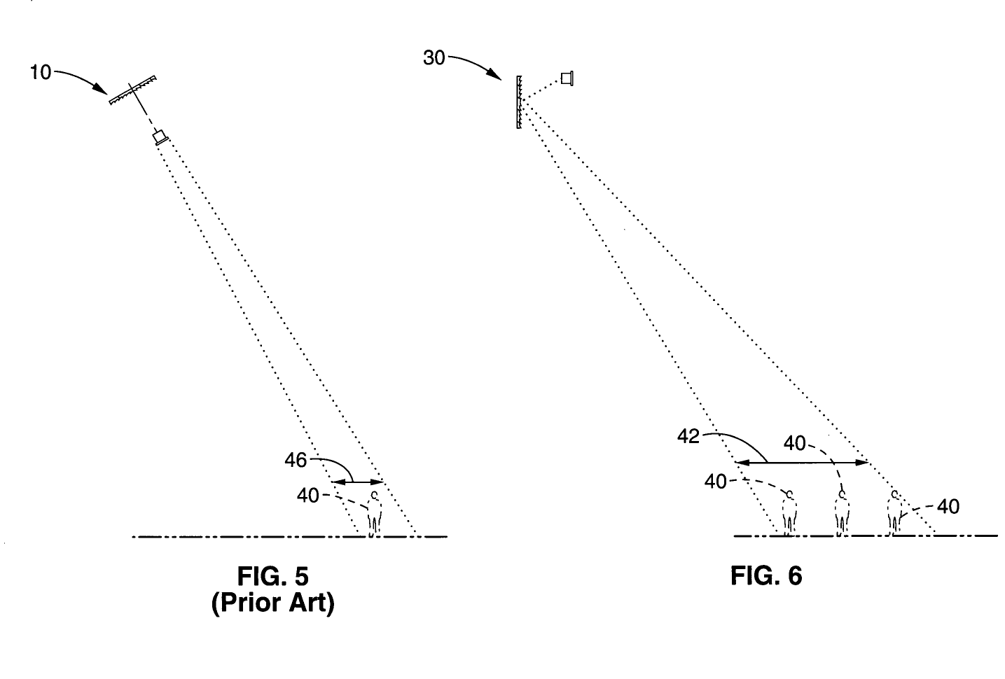

FIG. 5 and FIG. 6 show a comparison between a motion detector configured with a conventional pyroelectric detector assembly 10 and an astigmatically configured optical detector assembly 30 according to the present invention. FIG. 5 shows the conventional detector assembly 10 whose detection area subtends arc 46 in sensing motion of a human 40. FIG. 6 in comparison, illustrates the use of optical detector assembly 30 according to the present invention which provides an astigmatic beam spread thereby subtending a larger arc 42 in the plane of the drawing which increases the detection field within which humans 40 may be accurately detected. It will be further appreciated that both assemblies compared in FIG. 5 and FIG. 6 are configured with identical reflectors that produce an identical beam width perpendicular to the plane of the figures.

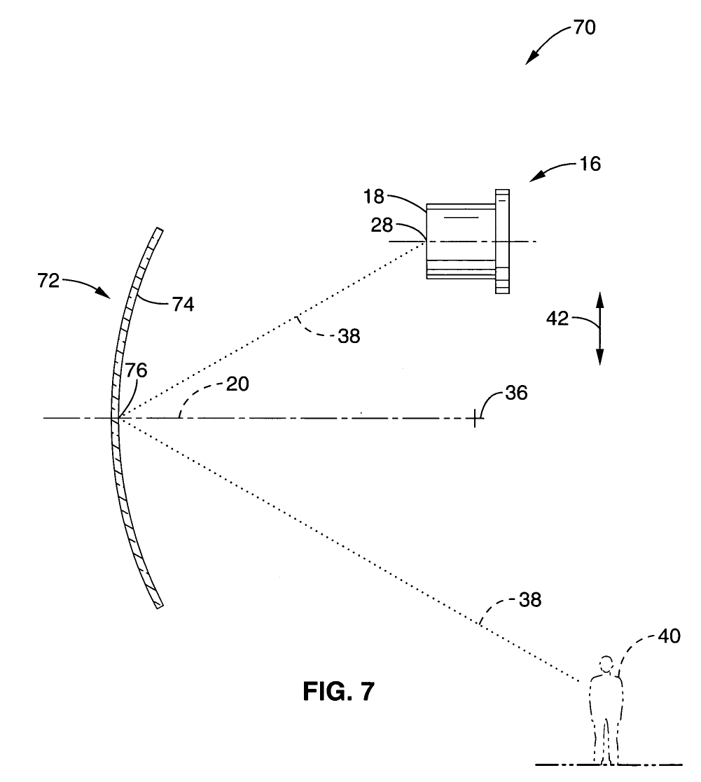

FIG. 7 is another embodiment of astigmatic optical detector assembly 70 that utilizes a physically curved reflector 72, preferably parabolic, or quasi-parabolic, which provides a reflecting surface 74 having an optical center 76. The curved reflector may consist of, or incorporate, flat portions, or facets, within the curve, so long as the resultant combination thereof provides for the collection and focusing of light toward a detector. The optics of curved reflector 72 are generally homologous to Fresnel reflector 12 of the previous figures. One of ordinary skill in the art will appreciate that variously curved mirrors and combinations may be used either separately or in conjunction comprising: curved portions, faceting, and Fresnel portions, without departing from the teachings of the invention.

Accordingly, it will be seen that this invention provides an optical detector assembly, and method of designing optical detector assemblies within motion detectors to provide an increased detection area in one axis that is readily and inexpensively implemented without the use of additional reflective structures. The assemblies and methods of the invention are also applicable to forms of reflectively sensed optical area detectors that do not provide “motion detection” per say, such as systems which may provide for sensing the absolute value of optical radiation emitted from an area. It will be appreciated that various forms of detectors responsive to electromagnetic radiation toward the infrared region of the spectrum may be utilized within the invention, and that off-axis positioning (astigmatic) may be varied according to the amount and direction of desired spread in an axis. Furthermore, the reflector used may be of various forms, as described, which provide an optically curved surface to focus light on a detector.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for detecting optical radiation, comprising:
(a) an optically curved mirror;
(b) said mirror having an optical axis;
(c) said mirror having a focal length;
(d) an optical detector; and
(e) means for positioning said optical detector in an astigmatic relationship with the optical axis of said mirror.

2. An apparatus as recited in claim 1, wherein said optical detector is positioned at a distance from said mirror that is substantially equivalent to the focal length of the mirror.

3. An apparatus as recited in claim 1, wherein the astigmatic relationship between said detector and the optical axis of said mirror comprises an angular offset greater than approximately ten degrees.

4. An apparatus as recited in claim 1, wherein said mirror comprises a Fresnel mirror.

5. An apparatus as recited in claim 1, wherein said mirror comprises a parabolic mirror.

6. An apparatus as recited in claim 1, wherein said optical detector comprises a pyroelectric sensor.

7. An apparatus as recited in claim 1, wherein said optical detector is configured to detect infrared radiation.

8. An apparatus as recited in claim 1, wherein said mirror has a physically curved reflective surface.

9. An apparatus as recited in claim 1, wherein said mirror is configured to direct incident electromagnetic radiation to said optical detector.

10. An apparatus for detecting optical radiation, comprising:
(a) an optically curved mirror;
(b) said mirror having an optical axis;
(c) said mirror having a focal length; and
(d) an optical detector;
(e) said optical detector positioned in an astigmatic relationship with the optical axis of said mirror.

11. An apparatus as recited in claim 10, wherein said optical detector is positioned at a distance from said mirror that is substantially equivalent to the focal length of the mirror.

12. An apparatus as recited in claim 10, wherein the astigmatic relationship between said detector and the optical axis of said mirror comprises an angular offset greater than approximately ten degrees.

13. An apparatus as recited in claim 10, wherein said mirror comprises a Fresnel mirror.

14. An apparatus as recited in claim 10, wherein said mirror comprises a parabolic mirror.

15. An apparatus as recited in claim 10, wherein said optical detector comprises a pyroelectric sensor.

16. An apparatus as recited in claim 10, wherein said optical detector is configured to detect infrared radiation.

17. An apparatus as recited in claim 10, wherein said mirror has a physically curved reflective surface.

18. An apparatus as recited in claim 10, wherein said mirror is configured to direct incident electromagnetic radiation to said optical detector.

19. An apparatus for detecting optical radiation within a detection area, comprising:
(a) an optically curved reflector;
(b) said reflector configured to reflect incident electromagnetic radiation;
(c) said reflector having an optical axis;
(d) said reflector having a focal length; and
(e) an optical detector;
(f) said optical detector positioned astigmatically, off-axis, in relation to the optical axis of said reflector;
(g) wherein said astigmatic positioning extends the detection area of said optical detector.

20. An apparatus as recited in claim 19, wherein said optical detector is positioned at a distance from said reflector that is substantially equivalent to the focal length of the reflector.

21. An apparatus as recited in claim 19, wherein the astigmatic relationship between said detector and the optical axis of said reflector comprises an angular offset greater than approximately ten degrees.

22. An apparatus as recited in claim 19, wherein said reflector comprises a Fresnel mirror.

23. An apparatus as recited in claim 19, wherein said reflector comprises a parabolic mirror.

24. An apparatus as recited in claim 19, wherein said optical detector comprises a pyroelectric sensor.

25. An apparatus as recited in claim 19, wherein said optical detector is configured to detect infrared radiation.

26. An apparatus as recited in claim 19, wherein said reflector has a physically curved reflective surface.

27. An apparatus as recited in claim 19, wherein said reflector is configured to direct incident electromagnetic radiation to said optical detector.

28. In an optical detector assembly of a motion sensing device utilizing an optical detector having a detection area upon which radiation is directed from an optically curved reflector having an optical axis and focal length, the improvement comprising positioning the optical detector in an astigmatic relationship with the optical axis of the reflector so that the resultant astigmatic beam spread extends the detection area along a detection axis.

29. An optical detector assembly as recited in claim 28, wherein said optical detector is positioned at a distance from said reflector that is substantially equivalent to the focal length of the reflector.

30. An optical detector assembly as recited in claim 28, wherein the astigmatic relationship between said detector and the optical axis of said reflector comprises an angular offset greater than approximately ten degrees.

31. An optical detector assembly as recited in claim 28, wherein said reflector comprises a Fresnel mirror.

32. An optical detector assembly as recited in claim 28, wherein said reflector comprises a parabolic mirror.

33. An optical detector assembly as recited in claim 28, wherein said optical detector comprises a pyroelectric sensor.

34. An optical detector assembly as recited in claim 28, wherein said optical detector is configured to detect infrared radiation.

35. An optical detector assembly as recited in claim 28, wherein said reflector has a physically curved reflective surface.

36. An optical detector assembly as recited in claim 28, wherein said reflector is configured to direct incident electromagnetic radiation to said optical detector.

37. An apparatus for detecting optical radiation within a detection area, comprising:
(a) an optically curved reflector;
(b) said reflector configured to reflect incident electromagnetic radiation;
(c) said reflector having an optical axis;
(d) said reflector having focal length; and
(e) an optical detector positioned astigmatically, off-axis, in relation to the optical axis of the reflector
(f) said optical detector responsive to electromagnetic radiation reflecting from the reflector that is incident on the optical detector;
(g) said optical detector having a detection area that is extended along an axis as a result of the astigmatic positioning.

38. An apparatus as recited in claim 37, wherein said optical detector is positioned at a distance from said reflector that is substantially equivalent to the focal length of the reflector.

39. An apparatus as recited in claim 37, wherein the astigmatic relationship between said detector and the optical axis of said reflector comprises an angular offset greater than approximately ten degrees.

40. An apparatus as recited in claim 37, wherein said reflector comprises a Fresnel mirror.

41. An apparatus as recited in claim 37, wherein said reflector comprises a parabolic mirror.

42. An apparatus as recited in claim 37, wherein said optical detector comprises a pyroelectric sensor.

43. An apparatus as recited in claim 37, wherein said optical detector is configured to detect infrared radiation.

44. An apparatus as recited in claim 37, wherein said reflector has a physically curved reflective surface.

45. A method of elongating the detection zone of an optical detector assembly along an axis, comprising:
configuring an optically curved reflector to focus incident electromagnetic radiation on an optical detector; and
positioning the optical detector, off-axis, in an astigmatic relationship with the optical axis of the optically curved reflector so that the detection zone is spread in one axis and results in elongation of the detection zone in that axis.

46. A method as recited in claim 45, further comprising positioned said optical detector at a distance from said reflector that is substantially equivalent to the focal length of the reflector.

47. A method as recited in claim 45, wherein the astigmatic relationship between said detector and the optical axis of said reflector comprises an angular offset greater than approximately ten degrees.

48. A method as recited in claim 45, wherein said reflector comprises a Fresnel mirror.

49. A method as recited in claim 45, wherein said reflector comprises a parabolic mirror.

50. A method as recited in claim 45, wherein said optical detector comprises a pyroelectric sensor.

51. A method as recited in claim 45, wherein said optical detector is configured to detect infrared radiation.

52. A method as recited in claim 45, wherein said reflector has a physically curved reflective surface.

53. A method as recited in claim 45, wherein said reflector is configured to direct incident electromagnetic radiation to said optical detector.
